(19) United States
(12) Patent Application Publication
(10) Pub. No.: US 2022/0220969 A1
(43) Pub. Date: Jul. 14, 2022

(54) PUMP MONITORING DEVICE, VACUUM PUMP, AND PRODUCT-ACCUMULATION DIAGNOSIS DATA PROCESSING PROGRAM

(71) Applicant: SHIMADZU CORPORATION, Kyoto-shi, Kyoto (JP)

(72) Inventor: Yusuke TAMAI, Kyoto-shi, Kyoto (JP)

(73) Assignee: SHIMADZU CORPORATION, Kyoto-shi Kyoto (JP)

(21) Appl. No.: 17/440,975

(22) PCT Filed: Nov. 20, 2019
(86) PCT No.: PCT/JP2019/045488

§ 371 Date: Sep. 20, 2021

(30) Foreign Application Priority Data
Mar. 27, 2019 (JP) 2019-061602

(51) Int. Cl. F04D 27/00; F04D 19/04

(52) U.S. Cl. CPC F04D 27/001; F04D 19/042

(57) ABSTRACT

Provided is a pump monitoring device diagnosing an accumulation of a reaction product in a vacuum pump. The pump monitoring device includes an acquisition unit configured to acquire data representing pump state of the vacuum pump, a statistical value calculation unit configured to calculate a statistical value representing a width of data distribution per predetermined time period, based on the data acquired by the acquisition unit, and a diagnosis unit configured to output diagnostic information of the vacuum pump about an amount of the accumulation of the reaction product, based on the statistical value.

### TECHNICAL FIELD

The present invention relates to a pump monitoring device, a vacuum pump, and a data processing program of diagnosing an accumulation of a reaction product.

### BACKGROUND ART

In a process such as dry etching or CVD for producing semiconductor devices or LCD panels, a vacuum pump such as a turbo-molecular pump is used to exhaust gas from a process chamber and keep the process chamber in high vacuum, to perform a process in the high vacuum process chamber. In this case, there is a problem that reaction product contained in the exhaust gas is solidified and accumulated in the pump due to cooling down of the reaction product inside the pump.

In the invention described in Patent Citation 1, maintenance time of a vacuum pump is determined by detecting motor current values of a motor rotating a rotor body, storing only motor current values having a set value or more among the motor current values in a steady rotation mode, calculating an average value of the stored motor current values per unit time, arranging the average values in time series to derive a linear approximation line of the average value, deriving a difference value between a predicted motor current value calculated using the linear approximation line and an initial motor current value when starting using the vacuum pump, and determining the time point when the difference value exceeds a predetermined threshold value as the maintenance time of the vacuum pump.

### PRIOR ART CITATIONS

### Patent Citation

Patent Citation 1: PCT publication WO 2013/161399

### SUMMARY OF INVENTION

### Technical Problem

Since there is an individual difference or an environmental difference between actual vacuum pumps, and the motor current values are not always the same under the same condition. Therefore, in determining the maintenance time, while an influence of the individual difference can be reduced by comparing with the motor current value in an initial state, it is difficult to eliminate an influence of the environmental difference, e.g. an influence of external conditions such as temperature, only by comparing with the motor current value in the initial state.

### Technical Solution

According to a first aspect of the present invention, a pump monitoring device is a pump monitoring device that diagnoses an accumulation of a reaction product in a vacuum pump, and comprises an acquisition unit configured to acquire data representing pump state of the vacuum pump, a statistical value calculation unit configured to calculate a statistical value representing a width of data distribution per predetermined time period, based on the data acquired by the acquisition unit, and a diagnosis unit configured to output diagnostic information of the vacuum pump about an amount of the accumulation of the reaction product, based on the statistical value.

According to a second aspect of the present invention, it is preferred that, in the pump monitoring device of the first aspect, when the statistical value reaches a tolerable upper limit value related to the amount of the accumulation of the reaction product, the diagnosis unit outputs diagnostic information indicating that pump maintenance time has come.

According to a third aspect of the present invention, it is preferred that the pump monitoring device of the first aspect comprises an alarm unit configured to output a pump maintenance alarm when the statistical value reaches a tolerable upper limit value related to the amount of the accumulation of the reaction product.

According to a fourth aspect of the present invention, it is preferred that, in the pump monitoring device of the first aspect, the statistical value calculation unit calculates at least one of a variance, a difference between a maximum value and a minimum value, an inter-quartile range, and a quantile range, as the statistical value.

According to a fifth aspect of the present invention, it is preferred that the pump monitoring device of the first aspect further comprises a pattern classification unit configured to retrieve the data acquired by the acquisition unit for each predetermined time period to classify the data by each similar data pattern, and it is preferred that the statistical value calculation unit calculates the statistical value based on the data pattern classified by the pattern classification unit.

According to a sixth aspect of the present invention, it is preferred that, in the pump monitoring device of the first aspect, the acquisition unit acquires motor current values having a predetermined current value or more as the data, and the predetermined current value is more than a no-load current value when the vacuum pump has no gas load.

According to a seventh aspect of the present invention, it is preferred that the pump monitoring device of the first aspect further comprises a smoothing unit configured to smooth the statistical value calculated by the statistical value calculation unit by using a smoothing filter, and it is preferred that the diagnosis unit performs the diagnosis based on the statistical value smoothed by the smoothing unit.

According to an eighth aspect of the present invention, a vacuum pump comprises the pump monitoring device according to the first aspect.

According to a ninth aspect of the present invention, a data processing program of diagnosing an accumulation of a reaction product causes a computer to execute a function of acquiring data representing pump state of a vacuum pump, a function of calculating a statistical value representing a width of data distribution per predetermined time period, based on the data, and a function of outputting diagnostic information of the vacuum pump about an amount of the accumulation of the reaction product, based on the statistical value.

### Advantageous Effects

According to the present invention, an influence of an environmental difference can be eliminated when diagnosing a vacuum pump, such as diagnosing maintenance time.

### BRIEF DESCRIPTION OF DRAWINGS

FIG. 1 is a diagram illustrating a vacuum processing device including a vacuum pump.

FIG. 2 is a cross-sectional view illustrating details of a pump.

FIG. 3 is a block diagram illustrating a structure of the vacuum pump and a main controller.

FIG. 4 is a functional block diagram of a pump monitoring unit.

FIG. 5 is a diagram illustrating an example of progression of motor current values during process.

FIG. 6 is a diagram illustrating another example of progression of motor current values during process.

FIG. 7 is a diagram illustrating of a current pattern when acquiring motor current values of a threshold value or more.

FIG. 8 is a diagram illustrating distribution of data xi.

FIG. 9 is a diagram illustrating a current pattern in a comparative example.

FIG. 10 is a diagram illustrating averages of the motor current values per unit time in the comparative example.

FIG. 11 is a diagram illustrating averages <x> of the motor current value per unit time Δt at t=t10 and at t=t20.

FIG. 12 is a diagram illustrating distributions D1 and D2 of current values at t=t10 and at t=t20.

FIG. 13 is a flowchart illustrating an example of a diagnosis process related to an accumulation of a reaction product.

FIG. 14 is a flowchart illustrating an example of a process of a statistical value calculation.

FIG. 15 is a diagram illustrating a computer and a server computer connected with each other via a communication line.

### DESCRIPTION OF EMBODIMENTS

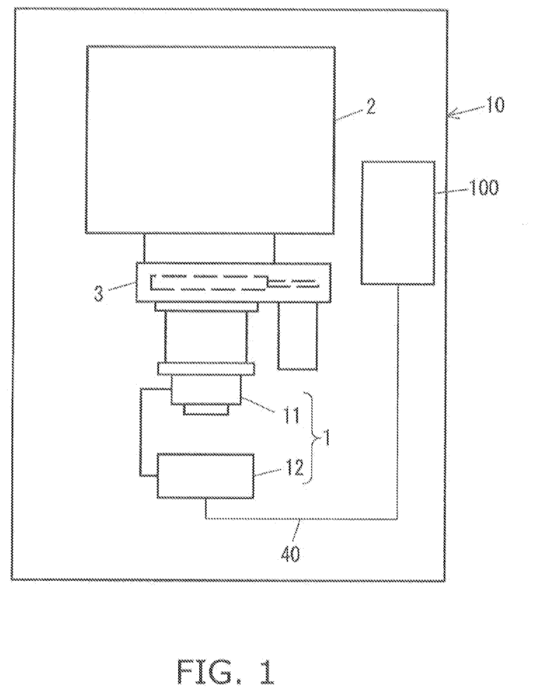

Hereinafter, with reference to the drawings, an embodiment for implementing the present invention is described. FIG. 1 is a diagram illustrating a schematic structure of a vacuum processing device 10 including a vacuum pump 1. The vacuum processing device 10 is, for example, an etching process or a film deposition device. The vacuum pump 1 is attached to a process chamber 2 via a valve 3. The vacuum processing device 10 is equipped with a main controller 100 configured to control the entire vacuum processing device 10 including the vacuum pump 1 and the valve 3. The vacuum pump 1 includes a pump 11 and a pump controller 12 configured to control and drive the pump 11. The pump controller 12 of the vacuum pump 1 is connected to the main controller 100 via a communication line 40.

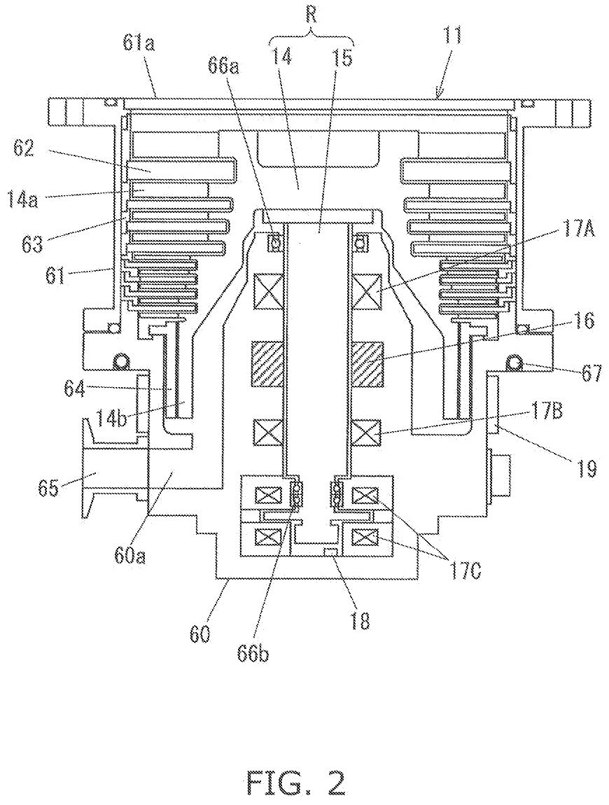

FIG. 2 is a cross-sectional view illustrating details of the pump 11. The vacuum pump 1 in this embodiment is a magnetic bearing type turbo-molecular pump, and the pump 11 includes a rotor body R supported by magnetic bearings. The rotor body R includes a pump rotor 14 and a rotor shaft 15 fastened to the pump rotor 14.

The pump rotor 14 has a plurality of stages of rotor blades 14a formed on an upstream side and a cylindrical part 14b constituting a screw groove pump formed on a downstream side. Corresponding to these, a plurality of fixed blade stators 62 and a cylindrical screw groove pump stator 64 are arranged on a fixed side. The screw groove pump has two types, one has the screw groove formed on an inner periphery surface of the screw groove pump stator 64, and the other has the screw groove formed on an outer periphery surface of the cylindrical part 4b. Each of the fixed blade stators 62 is placed on a base 60 via a spacer ring 63.

The rotor shaft 15 is supported by magnetic levitation using radial magnetic bearings 17A and 17B and an axial magnetic bearing 17C arranged to the base 60, and is rotatably driven by a motor 16. Each of the magnetic bearings 17A to 17C includes a bearing electromagnet and a displacement sensor, and a levitation position of the rotor shaft 15 can be detected by the displacement sensor. The rotational frequency of the rotor shaft 15 is detected by a rotational frequency sensor 18. When the magnetic bearings 17A to 17C are not in operation, the rotor shaft 15 is supported by emergency mechanical bearings 66a and 66b.

A pump casing 61 in which a gas inlet 61a is formed is bolt-fixed to the base 60. An exhaust port 65 is arranged to an gas outlet 60a of the base 60, and this exhaust port 65 is connected to a backing pump. When the motor 16 rotates the rotor shaft 15 with the pump rotor 14 at high speed, gas molecules on the gas inlet 61a side are exhausted to the exhaust port 65 side.

The base 60 is equipped with a heater 19 and a coolant pipe 67 in which coolant such as cooling water flows. The coolant pipe 67 is connected to a coolant supply pipe (not shown), and a flow rate of the coolant to the coolant pipe 67 can be adjusted by opening-closing control of an electromagnetic opening-closing valve (not shown) arranged to the coolant supply pipe. When exhausting the gas that is apt to accumulate a reaction product, in order to suppress accumulation of product at the screw groove pump and the rotor blade 14a on the downstream side, the heater 19 is turned on and off, and the flow of the coolant in the coolant pipe 67 is turned on and off, to perform temperature adjustment so that temperature of the base in a vicinity of a fixed part to which the screw groove pump stator 64 is fixed becomes a predetermined temperature, for example.

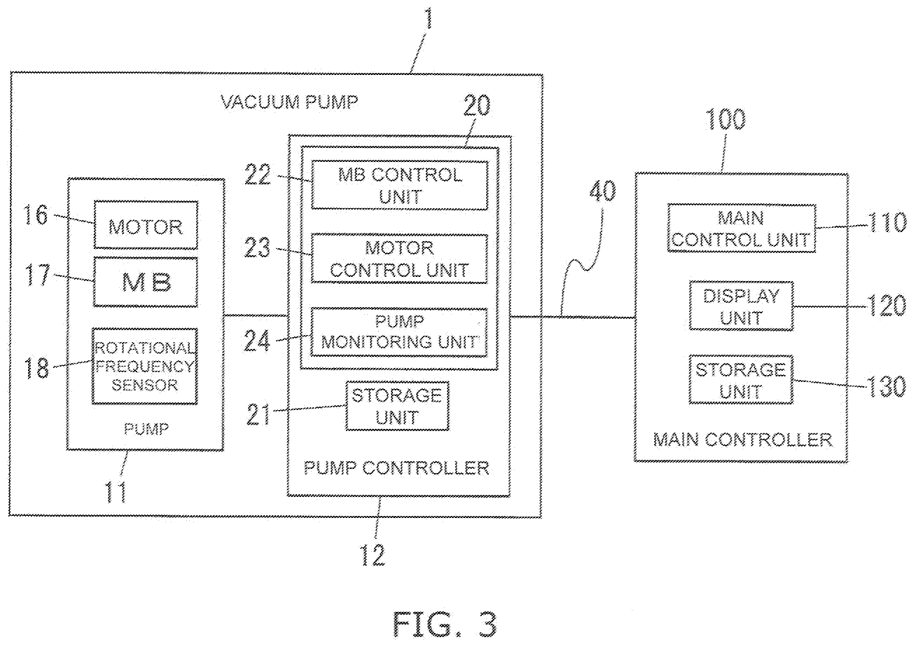

FIG. 3 is a block diagram illustrating a structure of the vacuum pump 1 arranged to the vacuum processing device 10 and a structure of the main controller 100. As also illustrated in FIG. 2, the pump 11 of the vacuum pump 1 includes the motor 16, the magnetic bearing (MB) 17, and the rotational frequency sensor 18. It should be noted that, in FIG. 3, the radial magnetic bearings 17A and 17B and the axial magnetic bearing 17C of FIG. 2 are referred to as the magnetic bearing 17 altogether. As described above, the magnetic bearing 17 includes the bearing electromagnet and the displacement sensor that detects a levitation position of the rotor shaft 15.

The pump controller 12 includes a CPU 20 and a storage unit 21. The CPU 20 functions as a magnetic bearing control unit (MB control unit) 22, a motor control unit 23, and a pump monitoring unit 24 in accordance with a control program stored in the storage unit 21. The storage unit 21 includes a memory such as a RAM and a ROM, and a recording medium such as a hard disk and a CD-ROM, and the control program is stored in the recording medium. When executing the control program, the CPU 30 reads the control program from the recording medium and stores the same in the memory. The main controller 100 includes a main control unit 110, a display unit 120, and a storage unit 130.

The motor control unit 23 estimates rotational frequency of the rotor shaft 15 based on a rotation signal detected by the rotational frequency sensor 18, and controls the motor 16 to have a predetermined target rotational frequency based on the estimated rotational frequency. Since load on the pump rotor 14 is increased when gas flow is increased, the rotational frequency of the motor 16 is decreased. The motor control unit 23 keeps the predetermined target rotational frequency by controlling the motor current so that the difference between the rotational frequency detected by the rotational frequency sensor 18 and the predetermined target rotational frequency (rated rotational frequency) becomes zero.

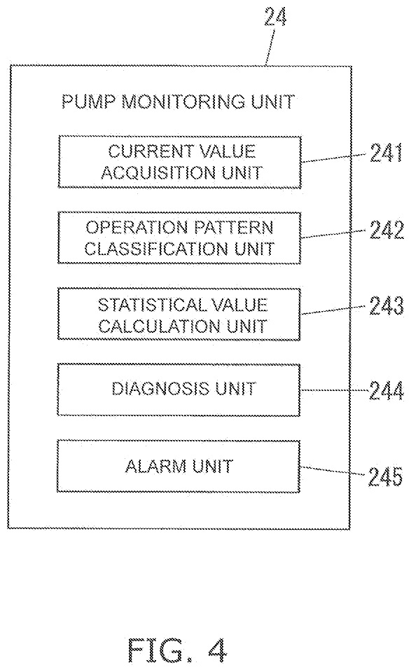

FIG. 4 is a functional block diagram of the pump monitoring unit 24. The pump monitoring unit 24 monitors an accumulation of the reaction product in the vacuum pump 1 based on data representing state of the vacuum pump 1. The following description exemplifies a case where a motor current value is used as the data representing state of the vacuum pump 1. The pump monitoring unit 24 includes a current value acquisition unit 241, an operation pattern classification unit 242, a statistical value calculation unit 243, a diagnosis unit 244, and an alarm unit 245. It is known that, when reaction product is accumulated in the vacuum pump 1, the state of the vacuum pump 1 is slightly changed, and the motor current value during gas exhaust is changed. Further, the inventor of the present invention found that a variation in the motor current value is changed in accordance with amount of the accumulation. The pump monitoring unit 24 diagnoses the accumulation of the reaction product in the vacuum pump 1 by focusing on the change of the variation of the motor current value.

The current value acquisition unit 241 acquires the motor current value detected by the motor control unit 23 of FIG. 3, from the motor control unit 23. As described later, when the process chamber 2 performs a plurality of processes, the motor current value (e.g. an average value of the motor current value during the process) is different depending on the process (operation pattern). The operation pattern classification unit 242 classifies the acquired data of the motor current value by the operation pattern as described later. The statistical value calculation unit 243 calculates a statistical value representing distribution width of the motor current values, based on the motor current value data classified by the operation pattern classification unit 242. In this embodiment, the statistical value representing the distribution width of the motor current value is used as information representing the variation of the motor current value.

The diagnosis unit 244 diagnoses the accumulation of the reaction product based on the statistical value representing the distribution width calculated by the statistical value calculation unit 243. It is confirmed that the statistical value representing the distribution width increases as an amount of the accumulation of the reaction product increases. The diagnosis unit 244 diagnoses that the amount of the accumulation of the reaction product has reached a tolerable upper limit value when a difference between the distribution width in a state of start of pump usage and the distribution width after the start of the pump usage reaches a determination threshold value. It should be noted that it may be possible to set the distribution width at the start of the usage of the pump as an initial value, and to diagnose that the amount of the accumulation of the reaction product has reached the tolerable upper limit value at the time point when the distribution with after the start of the usage reaches “the initial value plus the determination threshold value”, and this diagnosis is substantially the same as the case where the difference is used.

When the diagnosis unit 244 diagnoses that the amount of the accumulation of the reaction product has reached the tolerable upper limit value, the alarm unit 245 outputs a warning. For instance, the alarm unit 245 may be equipped with a display device, and the display device may display warning information, e.g. information notifying that maintenance time for removing the product has come, or the warning information can be sent to the main controller 100 via the communication line 40.

The motor current value acquired by the current value acquisition unit 241 is temporarily stored in the storage unit 21 and is used for the classification process by the operation pattern classification unit 242, and for the calculation of the statistical value by the statistical value calculation unit 243. The processes related to monitoring the accumulation of the reaction product described above are performed by executing a data processing program of diagnosing of the accumulation of the reaction product stored in the storage unit 21.

(Operation Pattern Classification Process)

Next, the pattern classification of the motor current value performed by the operation pattern classification unit 242 is described. Although not shown in FIG. 1, a general chamber structure of the vacuum processing device 10 includes a load lock chamber for taking a wafer from a clean room into the chamber, the process chamber 2 for processing the wafer, and a transfer chamber for carrying in and out of wafers between the load lock chamber and the process chamber 2.

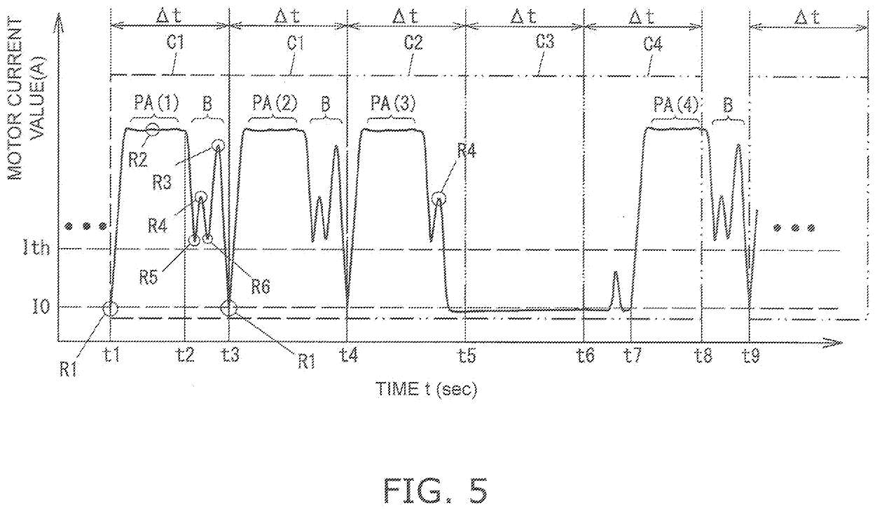

When one type of process PA is performed in the process chamber 2, the variation in the motor current value of the vacuum pump 1 is as schematically shown in FIG. 5. FIG. 5 is a diagram illustrating an example of progression of the motor current value during process, in which the vertical axis is the motor current value and the horizontal axis is time. When starting the introduction of the process gas into the process chamber 2 at t=t1, the motor current value is increased due to the gas load. When pressure inside the process chamber 2 is stabilized at a desired process pressure, the motor current value is also substantially constant. After that, the first time of the process PA is performed in the period denoted by PA(1).

After the first time of the process PA(1) is finished and the introduction of the process gas is stopped at t=t2, the pressure inside the process chamber 2 is decreased, and the motor current value is also decreased. During the period denoted by B, the processed wafer is carried out from the process chamber 2, and an unprocessed wafer is carried into the process chamber 2. When the carrying out and in of the wafers is finished, the introduction of the process gas into the process chamber 2 is restarted at t=t3.

In the example illustrated in FIG. 5, the same process PA is performed three times as shown by PA(1), PA(2) and PA(3) during the period from t=t1 to t=t5. In other words, three wafers are processed. After that, in the period from t=t5 to t=t6, wafer cassettes are exchanged in the load lock chamber. In the wafer cassette exchange period, the process in the process chamber 2 is not performed, and high vacuum in the chamber is maintained. Therefore, the motor load is decreased, and the motor current value is maintained at a small value. When the exchange of wafer cassettes is finished and the wafer is carried into the process chamber 2, the process gas is introduced at t=t7. After that, when the pressure inside the chamber is stabilized, the process is performed in the period denoted by PA(4).

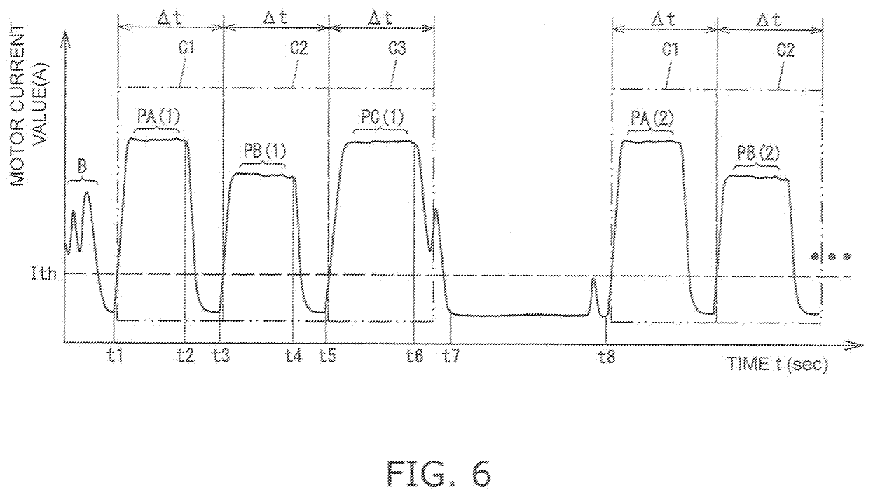

FIG. 6 is a diagram illustrating another example of progression of the motor current value during the process, which shows a case where three types of processes PA, PB and PC are performed in the process chamber 2. In other words, the processes PA, PB and PC are sequentially performed on the wafer carried into the process chamber 2.

When starting the introduction of the process gas into the process chamber 2 at t=t1, the motor current value is increased due to the gas load. When the pressure inside the process chamber 2 is stabilized at the desired process pressure, the motor current value is also substantially constant. After that, the process PA is performed in the period denoted by PA(1). When the process PA(1) is finished and the introduction of the process gas is stopped at t=t2, the pressure inside the process chamber 2 is decreased, and the motor current value is also decreased.

When the pressure inside the process chamber 2 is sufficiently decreased at t=t3, the process gas for the process PB is introduced. Further, when the pressure inside the chamber is stabilized at the process pressure for the process PB, the process PB is performed in the period denoted by PB(1). When the process PB(1) is finished and the introduction of the process gas for the process PB is stopped at t=t4, the pressure inside the chamber is decreased, and the motor current value is also decreased.

When the pressure inside the process chamber 2 is sufficiently decreased at t=t5, the process gas for the process PC is introduced. Then, when the pressure inside the chamber is stabilized, the process PC is performed in the period denoted by PC(1). When the process PC(1) is finished and the introduction of the process gas is stopped at t=t6, the pressure inside the process chamber 2 is decreased, and the motor current value is also decreased. After that, the processed wafer is carried out from the process chamber 2.

In the example illustrated in FIG. 6, the processes PA(1), PB(1) and PC(1) are sequentially performed on the same wafer in the period from t=t1 to t=t6. After the processes PA, PB and PC are performed on the wafer, the processed wafer is carried out from the process chamber 2 in the period from t=t6 to t=t7. In the period from t=t7 to t=t8, the exchange of wafer cassettes in the load lock chamber is performed. After that, an unprocessed wafer is carried into the process chamber 2, the introduction of the process gas is started at t=t8, and the process PA(2) is performed. After that, the process PB(2) and the process PC(2) are sequentially performed.

As illustrated in FIGS. 5 and 6, the motor current value varies depending on a type of the process or whether or not the process is being performed, or other factor. Therefore, in order to correctly detect the variation in the motor current value due to the influence of the amount of the accumulation of the reaction product, it is necessary to compare the motor current values in the same condition. In this embodiment, the motor current value data is classified by the operation pattern by performing a clustering on the motor current value data acquired by the current value acquisition unit 241.

The classification process by clustering is described by using the motor current values illustrated in FIG. 5 as an example. In the example illustrated in FIG. 5, the same type of the process PA is performed repeatedly, and substantially the same current pattern appears in the motor current values repeatedly. In order to perform the clustering, it is necessary to retrieve the acquired motor current values for each unit time.

In each process PA, the introduction of the process gas is started at timing R1 (e.g. t=t3 in FIG. 5) when the pressure inside the process chamber 2 after carrying out and in of wafers is sufficiently decreased to be a predetermined pressure. Δt the timing R1 to be the predetermined pressure, the motor current value is decreased to nearly I0. When starting the introduction of the process gas into the chamber, the motor current value is rapidly increased from I0.

As a method of setting the above-mentioned unit time that is a clustering time slot, for example, a predetermined time period Δt from the timing R1 when the motor current value becomes I0 is set as the clustering time slot. In the example illustrated in FIG. 5, the time period Δt from the timing R1 to a next timing R1 is set as the time slot (=unit time), but this is not a limitation. A next retrieval of the motor current values can be performed from the timing when the time period Δt elapses from the timing R1, and then the motor current value becomes I0.

In the example of FIG. 5, since the exchange of wafer cassettes is performed in the load lock chamber, the pressure inside the chamber is low after retrieving the motor current values in the period from t4 to t5, and the motor current value is near I0. In other words, since the motor current value is below I0 at timing t5 when the time period Δt elapses from t=t4, the retrieval of the motor current values is performed in the period from t5 to t6. Similarly, also in the period from t6 to t8, the retrieval of the motor current values is performed. It should be noted that, since the motor current value at t=t8 is above I0, the retrieval of the motor current values does not start at this timing, but the retrieval starts at timing t9 when the motor current value becomes less than I0 for the first time after t=t8.

In this way, the motor current values are retrieved for each time slot (time period) Δt, and then classification is performed by clustering. In this case, the classification is performed by focusing on the motor current values in a distinctive part of the current pattern. For instance, in the current pattern illustrated in FIG. 5, clustering is performed using points R2, R3 and R4 at which the current value has a peak, points R5 and R6 at which the current value has a minima, and the like, and it is classified into four types of current patterns including a cluster C1, a cluster C2, a cluster C3, and a cluster C4.

In the time slot Δt from t1 to t3 and the time slot Δt from t3 to t4 in which the same process PA is performed, the current patterns are substantially the same and are classified into the cluster C1. As a matter of course, if the conditions of the vacuum pump 1 are ideally the same, the current values are considered to be the same. In reality, however, the motor current value varies depending on difference of ambient temperature or the amount of the accumulation of the reaction product, or the individual difference of the vacuum pump 1, which also influences the current pattern. Since the current pattern of the time slot Δt from t4 to t5 has a difference in a shape of the pattern in the wafer carrying in and out period, compared with the current pattern of the two time slots Δt described above, it is classified into different cluster C2.

The current pattern of the time slot Δt from t5 to t6 is a current pattern in a period when the process is not performed, and classified into the cluster C3 that is different from the cluster C1 and the cluster C2. Since, in the time slot Δt from t6 to t8, the time slot is set such that a part of the current pattern of the process PA is acquired, and the current pattern is different from that of any one of the clusters C1 to C3, the current pattern is classified into the cluster C4. In the diagnosis of the accumulation of the reaction product using the statistical value, the cluster C1, the cluster C2, and the cluster C4 can be used, and the statistical value of one of these current patterns can be used, or a plurality of statistical values can be selected and used.

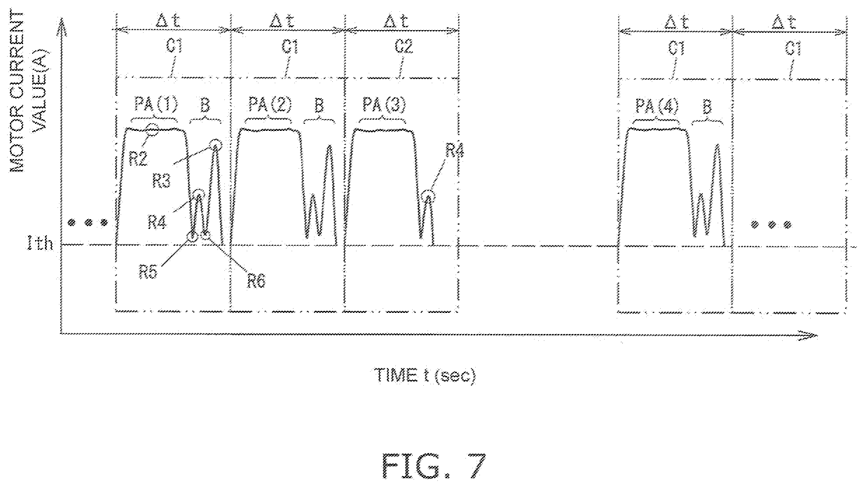

It should be noted that, if the motor current values of a threshold value Ith, which is more than a no-load current value when the vacuum pump 1 has no gas load, or more are acquired when the motor current values are acquired by the current value acquisition unit 241, the acquisition of a cluster that is not suitable for the diagnosis of the accumulation of the reaction product, such as the cluster C3, can be prevented. When acquiring only the motor current values of the threshold value Ith or more, the acquired motor current values are as illustrated in FIG. 7. In this case, only the clusters C1 and C2 are acquired, and more appropriate clustering can be performed.

In the example illustrated in FIG. 6, when only the motor current values of the threshold value Ith or more are acquired and the clustering is performed, the motor current values are classified into three types of clusters C1 to C3 corresponding to the processes PA, PB and PC. If the plurality of processes PA, PB and PC are included, it is also preferred to adopt the motor current value during the process, i.e. the motor current value in the range where the motor current value is stable in a peak, as a distinctive point for clustering.

(Calculation of Statistical Value)

The calculation of the statistical value by the statistical value calculation unit 243 is described. Conventionally, an average value of the motor current values per unit time was used as an index for estimating the amount of the accumulation of the reaction product, for example. In this embodiment, the statistical value representing distribution with of the motor current values is used as the index for estimating the amount of the accumulation of the reaction product. As such the statistical value, a variance, a difference between a maximum value and a minimum value, an inter-quartile range, a quantile range, or the like can be used.

When classifying the motor current value data by clustering and calculating the statistical value for the current pattern classified into the cluster C1 of FIG. 5, for example, average values xi (i=1, 2, 3, . . . n) of the motor current values acquired in the time slot Δt are calculated for the current pattern. The symbol n represents the number of the current pattern data classified into the cluster C1 by clustering, and is the number of data when calculating the statistical value. When <x> is the average value of n data xi, the variance V is calculated by the following equation (1).

$$\begin{matrix}[ Mathematical 1 ] & \\ V = \frac{1}{n} {\sum }_{i = 1}^{n} {( xi - 〈 x 〉 )}^{2} & ( 1 )\end{matrix}$$

It should be noted that the average value of the motor current values is used as the data xi in this embodiment, but the data xi is not limited to the average value and may be total current (Ah) obtained by accumulating current values in the time period from t=t1 to t=t2, for example.

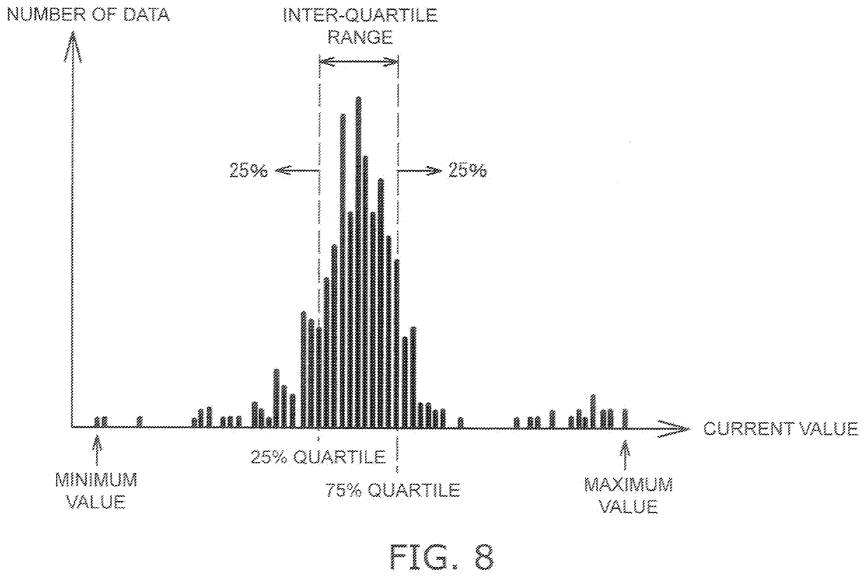

FIG. 8 is a diagram illustrating a distribution of the plurality of data xi, i.e. relationship between the current value and the number of data. In the distribution of FIG. 8, the inter-quartile range is a range of the current value (=current value difference) between the 25% quartile (first quartile) and the 75% quartile (third quartile). The left side (smaller value side) of the 25% quartile contains 25% of all data, while the right side (larger value side) of the 75% quartile also contains 25% of all data. In addition, the median of the current values of all data is referred to as a second quartile. In addition, the quantile range is a range of the current value range (=current value difference) between the M % quartile and the (100−M)% quartile.

(Advantage of Statistical Value Representing Distribution Width)

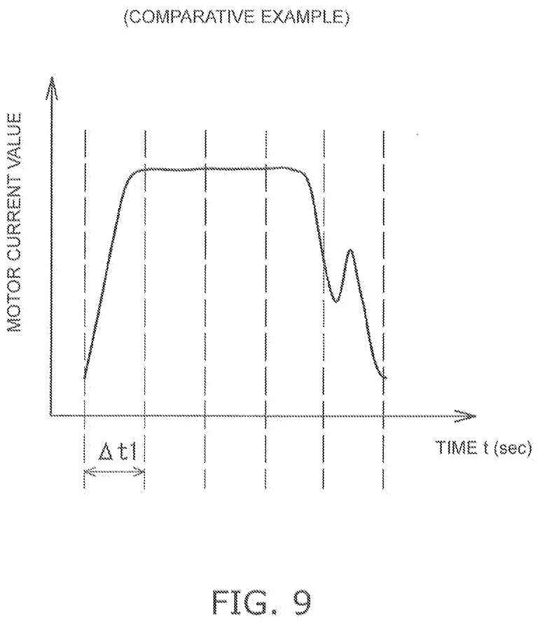

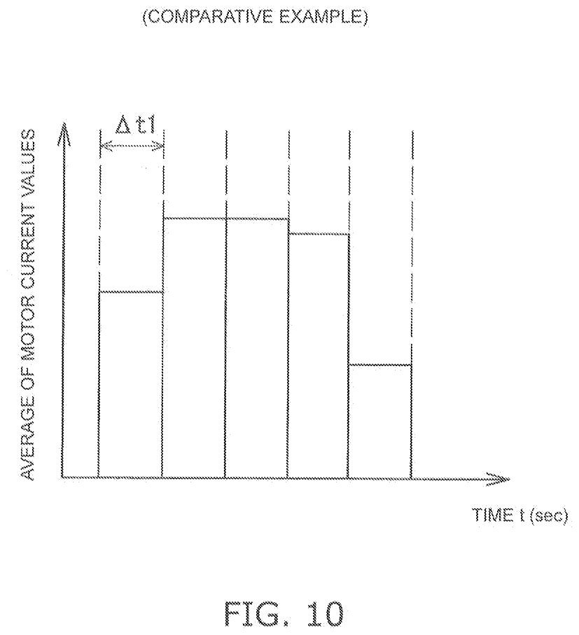

As a comparative example, if an average of the motor current values per unit time is used, the motor current values are acquired by the method illustrated in FIGS. 9 and 10, for example. FIG. 9 illustrates the current pattern of the cluster C2 of FIG. 7, and FIG. 10 illustrates a bar chart of averages of the motor current values per unit time. In FIGS. 9 and 10, Δt1 is the unit time for calculating the average. In the comparative example, a variation is generated in the calculated average values depending on the timing in the current pattern when the average of the motor current values per unit time is calculated. As a matter of course, if the unit time Δt1 is set to the same level as the time width Δt of the cluster C2 (see FIG. 7), the average of the motor current values becomes the same level of value as the average value xi described above.

When the average of the motor current values per unit time Δt1 as illustrated in FIG. 10 is used, the average value of the current values in an arbitrary Δt1 in the distribution illustrated in FIG. 9 are acquired. In Patent Citation 1, averages of the motor current values per unit time acquired in this way are arranged in time series to derive a linear approximation line, and the maintenance time is determined as the point when the difference between the motor current value predicted from the linear approximation line and the motor current value at the start of usage of the pump exceeds the threshold value.

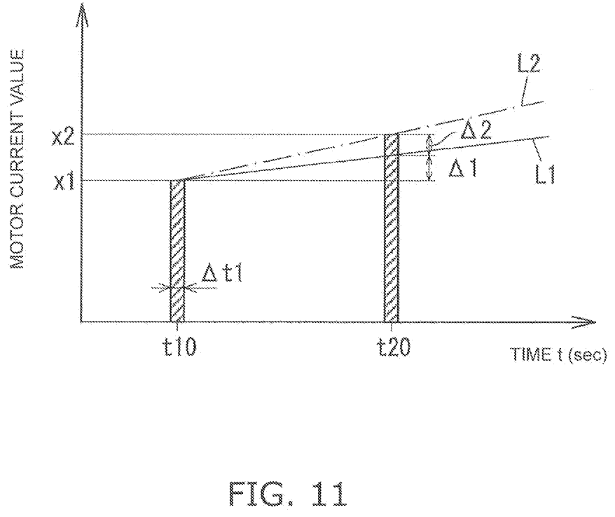

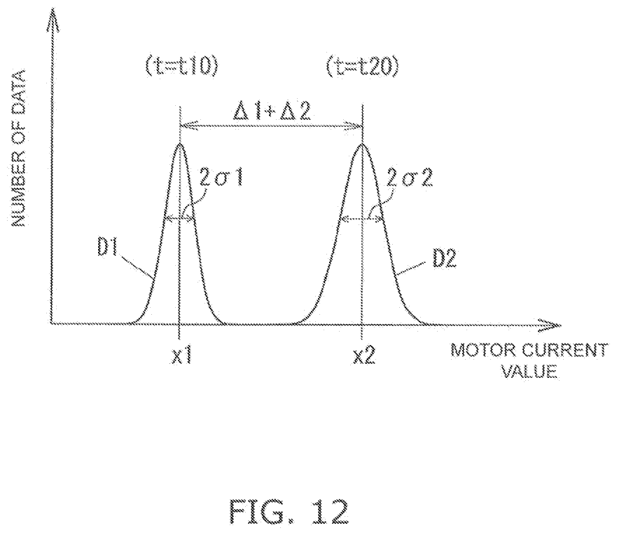

An advantage of using the statistical value representing the distribution width of the motor current value as the index of the amount of the accumulation of the reaction product is described with reference to FIGS. 11 and 12. FIG. 11 illustrates a case of using the average of the motor current values per unit time Δt1. FIG. 12 illustrates a case of using the statistical value representing the distribution width of the motor current value like this embodiment. Here, a case of using variance σ² as the statistical value representing the distribution width is exemplified and described.

In FIG. 11, the average values of the motor current values at t=t10 and at t=t20 are x1 and x2, respectively. Environmental conditions and the amount of the accumulation of the reaction product are different between t=t10 and t=t20, and it is supposed that change (=increase) in the motor current average value due to the amount of the accumulation of the reaction product at t=t20 is Δ1, while a change in the motor current average value due to the environmental condition is Δ2.

When estimating the influence of the amount of the accumulation of the reaction product based on the average values x1 and x2 of the motor current value, the current value increase Δ2 due to the environmental condition can be regarded as an error factor. Therefore, a linear line L2 estimated from the average values x1 and x2 of the motor current value is different from the linear line L1 estimated when considering only the current value increase Δ1 due to the amount of the accumulation of the reaction product. In other words, a change in the environmental condition causes an error in estimating the maintenance time due to the accumulation of the reaction product.

FIG. 12 schematically illustrates distributions D1 and D2 of the motor current values at t=t10 and at t=t20 in FIG. 11. Here, it is assumed that the distributions D1 and D2 are normal distribution, and variances of the distributions D1 and D2 are denoted by σ1² and σ2², respectively.

In the case of the statistical value representing the distribution width of the motor current value, which is used for the diagnosis of the accumulation of the reaction product in this embodiment, the motor current value (the average value thereof) of the plurality of current patterns classified into the same cluster by clustering is distributed as illustrated in FIG. 8. Since the time period for acquiring the plurality of data xi is approximately 2 min, the current value increase Δ2 in the plurality of data xi acquired during this time period can be considered to be substantially the same. In other words, the variation in the motor current value due to the change in the environmental condition has an influence such that the entire of the plurality of data xi illustrated in FIG. 8 moves in the increasing direction or in the decreasing direction. On the other hand, if the amount of the accumulation of the reaction product increases, the increase Δ1 occurs in the motor current average value as described above.

Therefore, medians of the distributions D1 and D2 are values x1 and x2, respectively, and the distribution D2 is shifted from the distribution D1 by the difference x2−x1 as illustrated in FIG. 12. This difference x2−x1 is due to, as described above, the increase Δ1 in the motor current average value due to the amount of the accumulation of the reaction product, and the increase Δ2 in the motor current average value due to the environmental condition, and it equals to Δ1+2. Furthermore, it is found that, when the amount of the accumulation of the reaction product is increased, the distribution width that is the variation in the plurality of data xi is increased, and even if the environmental condition (such as ambient temperature) is changed, the distribution width does not change. In other words, by monitoring an increase in this variance σ², the amount of the accumulation of the reaction product can be diagnosed without being affected by the change in the environmental condition (environmental difference).

The statistical value calculation unit 243 illustrated in FIG. 4 calculates the statistical value representing the distribution width based on the plurality of data xi. As the statistical value representing the distribution width, there are a variance, a difference between a maximum value and a minimum value, an inter-quartile range, a quantile range, and the like. At least one of these is calculated by the statistical value calculation unit 243, and the variance is calculated in the example described above.

The diagnosis unit 244 diagnoses the amount of the accumulation of the reaction product based on the calculated statistical value. Specifically, when the vacuum pump 1 is mounted to the process chamber 2 of the vacuum processing device 10 and starts its usage, it calculates the statistical value (initial statistical value) based on the plurality of data xi acquired at the beginning of use. Then, it calculates the difference (i.e. a present statistical value−the initial statistical value), which is an increase in the statistical value calculated at a present time point from the calculated initial statistical value. When the calculated difference reaches a predetermined tolerable upper limit value, the alarm unit 245 outputs the warning.

It should be noted that, in the diagnosis unit 244, linear function fitting (Savitzky-Golay filter) or the like by a least-squares method may be applied to a temporal change in the calculated statistical value, to smooth the statistical value. In this case, the difference between the statistical value after the smoothing and the initial state is calculated, and the warning is outputted at the time point when the difference reaches the tolerable upper limit value. By smoothing the statistical value, an influence of up and down swing in the statistical value due to noise or the like can be prevented when comparing with the tolerable upper limit value.

In addition, the tolerable upper limit value may be set as a value when maintenance due to the accumulation of the reaction product is necessary. The diagnosis unit 244 derives the linear approximation line by arranging the statistical values in time series, and uses the linear approximation line to diagnose the time point when the statistical value reaches “the initial statistical value plus the tolerable upper limit value” as the maintenance time. The alarm unit 245 not only outputs the warning at the time point when the difference reaches the tolerable upper limit value, but also informs about the estimated maintenance time as maintenance information.

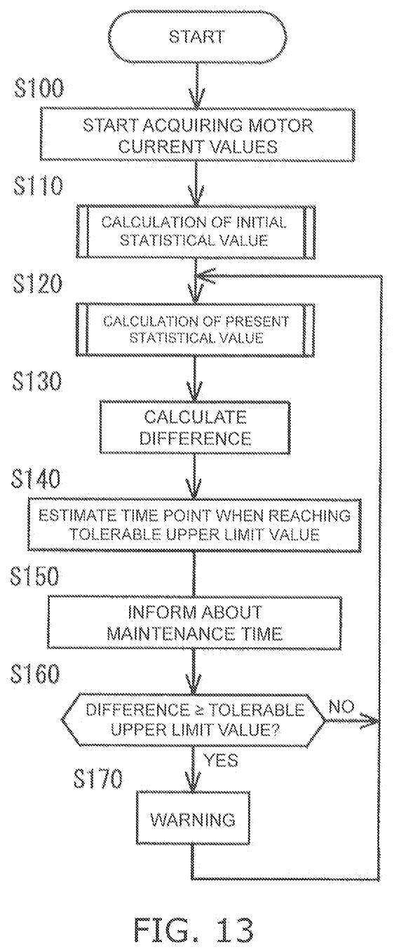

FIG. 13 is a flowchart illustrating an example of the process related to the accumulation diagnosis performed by the pump monitoring unit 24. This process is performed by executing the program stored in the storage unit 21 when starting the pump.

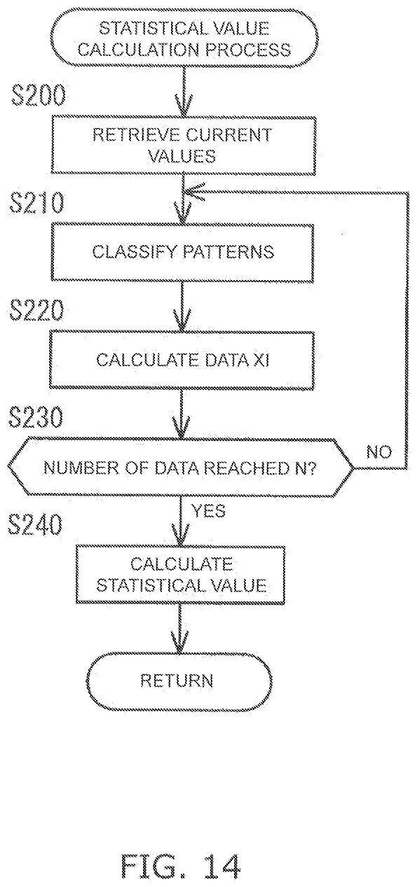

In Step S100 in FIG. 13, the current value acquisition unit 241 starts acquiring the motor current values. In Step S110, a statistical value calculation process illustrated in FIG. 14 is performed in a pump start initial period, to calculate the initial statistical value described above. When the calculation of the initial statistical value is finished, the process proceeds to Step S120, and the present statistical value that is the statistical value after the pump start initial period is calculated by the statistical value calculation process illustrated in FIG. 14.

Next, in Step S130, the difference between the present statistical value calculated in Step S120 and the initial statistical value calculated in Step S110 (i.e. the present statistical value−the initial statistical value) is calculated. The calculated difference is stored in the storage unit 21. In Step S140, the linear approximation line representing a time series variation of the calculated difference is derived, and the linear approximation line is used to estimate the time point when the difference reaches the tolerable upper limit value. Here, the tolerable upper limit value is used as an upper limit value related to the maintenance time. In Step S150, the alarm unit 245 informs about the maintenance time estimated in Step S140 as the maintenance information.

It should be noted that, instead of using the linear approximation line of the difference, the linear approximation line of the statistical value is derived, and the time point when the statistical value reaches “the initial statistical value plus the tolerable upper limit value” is determined as the maintenance time.

In Step S160, it is determined whether or not the difference calculated in Step S130 has reached the tolerable upper limit value, i.e., whether or not the amount of the accumulation of the reaction product has reached the tolerable upper limit. If it is determined in Step S160 that the difference has reached the tolerable upper limit value, the process proceeds to Step S170, and the alarm unit 245 outputs the warning. On the other hand, if it is determined in Step S160 that the difference has not reached the tolerable upper limit value, the process proceeds to Step S120.

(Statistical Value Calculation Process)

FIG. 14 is a flowchart of the statistical value calculation process in Steps S110 and S120. In Step S200, the current values from current rise until lapse of unit time Δt is retrieved from the acquired motor current values. In Step S210, the pattern classification described above is performed on the current values retrieved in Step S200. In Step S220, for the same pattern classification classified in Step S210, the current average values xi (data xi) described above are each calculated. In Step S230, it is determined whether or not the number of data xi has reached n. If the number of data has not reached n, the process returns to Step S210. If the number of data has reached n, the process proceeds to Step S240. In Step S240, the statistic (such as the variance) is calculated based on the n data xi.

(Alternative Examples)

In the embodiment described above, the plurality of data xi are calculated for the same classification of the current pattern by performing clustering. When performing the diagnosis of the accumulation of the reaction product using the statistical value described above, the classification by clustering as described above is not necessarily needed. For instance, for the current patterns illustrated in FIG. 7, the retrieval start timing may not be limited to the current rise timing, the current values may be retrieved by the unit time that is approximately several times of Δt, and the average value of the current values may be calculated. Further, the statistical value is calculated using the n motor current average values acquired without classification, as the data xi.

In the alternative example, while the variation in the data xi is increased and the distribution width is also increased, compared with the classification by clustering, the amount of the accumulation of the reaction product can be determined based on the magnitude of the distribution width. It should be noted that, by increasing the unit time for the retrieval, the variation in the data xi can be small.

A person skilled in the art can understand that the plurality of the exemplary embodiments described above are concrete examples of the following aspects.

[1] The pump monitoring device according to one aspect is a pump monitoring device for diagnosing the accumulation of the reaction product in a vacuum pump, including an acquisition unit configured to acquire data representing pump state of the vacuum pump, a statistical value calculation unit configured to calculate a statistical value representing a width of data distribution per predetermined time period, based on the data acquired by the acquisition unit, and a diagnosis unit configured to output diagnostic information of the vacuum pump about the amount of the accumulation of the reaction product, based on the statistical value.

For instance, as illustrated in FIG. 12, the current value distribution D1 per predetermined time period at t=t10 becomes the distribution D1 at t=t20. Further, the statistical values representing the widths of the distributions D1 and D2 (e.g., the variances σ1² and σ2²) are not affected by the change in the environmental condition (environmental difference), but are increased when the amount of the accumulation of the reaction product is increased. In other words, by monitoring the increase in the statistical value representing the distribution width of the current values, the amount of the accumulation of the reaction product can be diagnosed without being affected by the change in the environmental condition (environmental difference).

It should be noted that, in the embodiment described above, the current values of the motor 16 for the vacuum pump 1 are acquired, the statistical value representing the distribution width of the current values per predetermined time period is calculated, and the amount of the accumulation of the reaction product is determined based on the statistical value. However, the data representing state of the vacuum pump 1, which is affected by the amount of the accumulation of the reaction product, is not limited to the motor current value. A motor power representing the motor load, or a current value of the displacement sensor, a magnetic bearing current value, or a magnetic bearing power, which are data related to an influence to the magnetic levitation, or the like can also be used as the data representing the pump state. Further, the statistical value representing the width of data distribution representing the pump state is calculated, and the amount of the accumulation of the reaction product is determined based on the statistical value.

Due to the accumulation of the reaction product on the pump rotor 14, a weight of the pump rotor 14 or rotor imbalance is increased. For instance, if the rotor imbalance is increased, an amount of swing of the rotation of the pump rotor 14 levitated magnetically is increased, and the variation in the rotor levitation position is also increased. Therefore, by using the statistical value representing the distribution width of the current values of the displacement sensor, the diagnosis of the amount of the accumulation of the reaction product can be performed.

[2] In the pump monitoring device described above in [1], when the statistical value reaches an tolerable upper limit value related to the amount of the accumulation of the reaction product, the diagnosis unit outputs diagnostic information indicating that pump maintenance time has come. As a result, the pump maintenance time can be diagnosed without being affected by the change in the environmental condition (environmental difference).

[3] The pump monitoring device described above in [1] or [2] comprises an alarm unit configured to output a pump maintenance alarm when the statistical value reaches the tolerable upper limit value related to the amount of the accumulation of the reaction product.

As shown in Step S160 in FIG. 13, by determining whether or not the difference, i.e. the present statistical value minus the initial statistical value, has reached the tolerable upper limit value, namely by determining whether or not the statistical value has reached the tolerable upper limit value related to the amount of the accumulation of the reaction product, it is possible to diagnose that the maintenance time related to the accumulation of the reaction product has come. Then, by outputting a warning from the alarm unit 245, the maintenance of the vacuum pump can be performed without delay, and the occurrence of a malfunction due to the accumulation of the reaction product can be prevented in advance.

[4] In the pump monitoring device described above in any one of [1] to [3], the statistical value calculation unit calculates at least one of a variance, a difference between a maximum value and a minimum value, an inter-quartile range, and a quantile range, as the statistical value.

As the statistical value representing the distribution width, the difference between the maximum value and the minimum value, the inter-quartile range, the quartile range, or the like can be used other than the variance. Further, by using a plurality of statistical values, reliability of the diagnosis of the accumulation of the reaction product can be improved. For instance, since, if three statistical values are used, it is diagnosed that the maintenance time has come only when all the statistical values have reached the tolerable upper limit value, an influence of an exceptional situation that one statistical value temporarily exceeds the tolerable upper limit value due to noise or other factor can be prevented.

[5] The pump monitoring device described above in any one of [1] to [4] further comprises a pattern classification unit configured to retrieve the data acquired by the acquisition unit for each predetermined time period to classify the data by each similar data pattern, and the statistical value calculation unit calculates the statistical value based on the data pattern classified by the pattern classification unit.

For instance, if there are a plurality of operation patterns as illustrated in FIG. 6, an amount of gas flow or an opening ratio of the valve 3 varies differently depending on the operation pattern. Therefore, even if the same amount of product is accumulated in the pump, the motor current values per unit time may be different depending on the operation pattern. On the contrary to this, by retrieving the acquired current values for each predetermined time period to classify them by each similar data pattern as described above, the same operation pattern is classified into the same current pattern. As a result, the diagnosis of the accumulation of the reaction product can be performed without being affected by other operation patterns.

[6] In the pump monitoring device described above in any one of [1] to [5], the acquisition unit acquires the motor current values having a predetermined current value or more as the data, the predetermined current value is more than a no-load current value when the vacuum pump has no gas load.

For instance, as described above with reference to FIG. 6, when acquiring the motor current values, the motor current values of the threshold value Ith, which is more than the no-load current value, or more are acquired. Thus, the statistical value representing the distribution width of the current values per predetermined time period can be calculated more accurately. In other words, since, if the section of the no-load current value is included, it affects the distribution width, the statistical value is affected by the factor other than the accumulation of the reaction product, and accuracy of the diagnosis of the accumulation of the reaction product is deteriorated. However, as described above, by acquiring the motor current values of the predetermined current value, which is more than the no-load current value when the vacuum pump has no gas load, or more, such deterioration of diagnosis accuracy can be prevented.

In addition, if the current values are retrieved for each predetermined time period to classify them by each similar data pattern, the acquisition of the cluster that is not related to the process and affects badly to the accumulation of the reaction product diagnosis, such as cluster C3 illustrated in FIG. 5, can be prevented.

[7] The pump monitoring device described above in any one of [1] to [6] further comprises a smoothing unit configured to smooth the statistical value calculated by the statistical value calculation unit by using a smoothing filter, and the diagnosis unit performs the diagnosis based on the statistical value smoothed by the smoothing unit.

By applying the smoothing filter such as the linear function fitting (Savitzky-Golay filter) using the least-squares method to a temporal change of the calculated statistical value to smooth the statistical value in the diagnosis unit 244, when comparing with an tolerable increase, an influence of up and down swing in the statistical value due to noise or the like can be prevented.

[8] The vacuum pump includes the pump monitoring device described above in any one of [1] to [7]. By including the pump monitoring device in the vacuum pump, the amount of the accumulation of the reaction product can be diagnosed without being affected by the change in the environmental condition (environmental difference), and the maintenance of the vacuum pump can be appropriately performed.

[9] The data processing program of diagnosing the accumulation of the reaction product according to one aspect causes a computer to execute a function of acquiring data representing pump state of a vacuum pump, a function of calculating a statistical value representing a width of data distribution per predetermined time period, based on the data, and a function of outputting diagnostic information of the vacuum pump about the amount of the accumulation of the reaction product, based on the statistical value.

By executing the data processing program of diagnosing the accumulation of the reaction product in the pump monitoring unit 24 arranged in the pump controller 12 of the vacuum pump 1, the accumulation of the reaction product in the vacuum pump 1 can be easily diagnosed.

The data processing program of diagnosing the accumulation of the reaction product can be provided via a non-transitory computer readable recording medium such as a CD-ROM or a DVD-ROM, or via a data signal on the Internet or the like. The program can also be sent to a processing device such as a CPU, as a data signal on a carrier wave. In this way, the program can be provided as a computer readable computer program product in various forms such as a recording medium or data on a carrier wave.

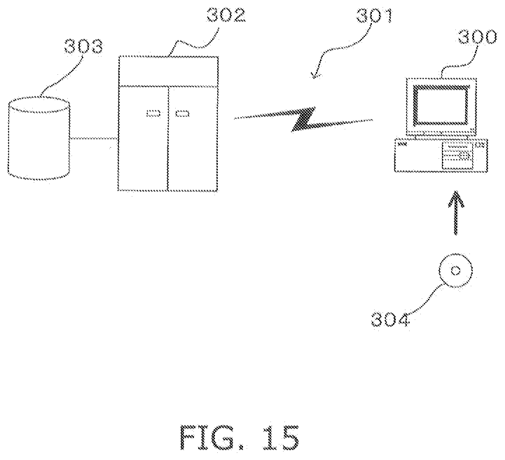

FIG. 15 is a diagram illustrating a computer and a server computer connected with each other via a communication line. A personal computer 300 is provided with a program via a CD-ROM 304. In addition, the personal computer 300 has a function of connecting to a communication line 301. A computer 302 is a server computer that provides the program described above and stores the program in a recording medium such as a hard disk 303. The communication line 301 is a communication line such as the Internet or a personal computer communication, a dedicated communication line, or the like. The computer 302 reads the program from the hard disk 303 and sends the program to the personal computer 300 via the communication line 301. In other words, the program is sent as a data signal embodied on a carrier wave via the communication line 301. In this way, the program can be provided as a computer readable computer program product in various forms such as a recording medium or data on a carrier wave.

Although the embodiments and alternative examples are described above, the present invention is not limited to these. Other aspects, which can be considered within the technical concept of the present invention, are also included in the scope of the present invention. For instance, in the embodiment described above, the pump monitoring unit 24 is arranged in the pump controller 12 of the vacuum pump 1, but the pump monitoring unit 24 may be arranged as a separate device independent of the pump controller 12. In addition, various types of pumps can be used as the vacuum pump 1, without limiting to the magnetic bearing type turbo-molecular pump.

The contents disclosed in the following basic patent application for the priority right are hereby incorporated by reference:

Japanese Patent Application No. 2019-061602 (filed Mar. 27, 2019).

### REFERENCE SIGNS LIST

1 vacuum pump

2 process chamber

10 vacuum processing device

11 pump

12 pump controller

16 motor

17 magnetic bearing

20 CPU

21 storage unit

24 pump monitoring unit

241 current value acquisition unit

242 operation pattern classification unit

243 statistical value calculation unit

244 diagnosis unit

245 alarm unit

1. A pump monitoring device diagnosing an accumulation of a reaction product in a vacuum pump, the device comprising:
an acquisition unit configured to acquire data representing pump state of the vacuum pump;
a statistical value calculation unit configured to calculate a statistical value representing a width of data distribution per predetermined time period, based on the data acquired by the acquisition unit; and
a diagnosis unit configured to output diagnostic information of the vacuum pump about an amount of the accumulation of the reaction product, based on the statistical value.

2. The pump monitoring device according to claim 1, wherein, when the statistical value reaches a tolerable upper limit value related to the amount of the accumulation of the reaction product, the diagnosis unit outputs diagnostic information indicating that pump maintenance time has come.

3. The pump monitoring device according to claim 1, further comprising an alarm unit configured to output a pump maintenance alarm when the statistical value reaches a tolerable upper limit value related to the amount of the accumulation of the reaction product.

4. The pump monitoring device according to claim 1, wherein the statistical value calculation unit calculates at least one of a variance, a difference between a maximum value and a minimum value, an inter-quartile range, and a quantile range, as the statistical value.

5. The pump monitoring device according to claim 1, further comprising a pattern classification unit configured to retrieve the data acquired by the acquisition unit for each predetermined time period to classify the data by each similar data pattern,
wherein the statistical value calculation unit calculates the statistical value based on the data pattern classified by the pattern classification unit.

6. The pump monitoring device according to claim 1, wherein the acquisition unit acquires motor current values having a predetermined current value or more as the data, the predetermined current value being more than a no-load current value when the vacuum pump has no gas load.

7. The pump monitoring device according to claim 1, further comprising a smoothing unit configured to smooth the statistical value calculated by the statistical value calculation unit by using a smoothing filter,
wherein the diagnosis unit performs the diagnosis based on the statistical value smoothed by the smoothing unit.

8. A vacuum pump comprising the pump monitoring device according to claim 1.

9. A data processing program of diagnosing an accumulation of a reaction product that causes a computer to execute:
a function of acquiring data representing pump state of a vacuum pump;
a function of calculating a statistical value representing a width of data distribution per predetermined time period, based on the data; and
a function of outputting diagnostic information of the vacuum pump about an amount of the accumulation of the reaction product, based on the statistical value.
